(19) United States
(12) Patent Application Publication
(10) Pub. No.: US 2007/0025106 A1
(43) Pub. Date: Feb. 1, 2007

(54) Night vision compatible area light fixture

(75) Inventor: Timothy R. Robinson, Lake Forest Park, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Korry Electronics Co., Seattle, WA (US)

(21) Appl. No.: 11/193,040

(22) Filed: Jul. 29, 2005

(51) Int. Cl. F21V 9/00; F21V 11/00

(52) U.S. Cl. 362/293; 362/235

(57) ABSTRACT

A night vision equipment compatible area light fixture may include a housing, one or more LEDs such as gallium nitride or indium gallium nitride LEDs, and a filter assembly positioned to filter electromagnetic radiation with a wavelength of 950 nm. The filer may, for example, substantially block electromagnetic radiation with wavelengths between approximately 930 nm and approximately 1000 nm. The filter may additionally, for example, substantially blocking electromagnetic radiation with wavelengths between approximately 900 nm and approximately 1000 nm. The filter may further, for example, substantially block electromagnetic radiation with wavelengths between approximately 700 nm and approximately 1000 nm.

### BACKGROUND OF THE INVENTION

1. Field of the Invention

Embodiments described herein are generally related to area lighting, and more particularly to area light fixtures that are compatible with night vision equipment.

2. Description of the Related Art

Night vision equipment such as night vision imaging systems (NVIS), night vision devices (NVDs), night vision goggles (NVGs), and/or image intensifiers, is commonly used in the military or by security personnel for many purposes. For example, night vision equipment may be used for night reconnaissance, or for aircraft take-offs and landings at night.

Night vision equipment amplifies and converts ambient and artificially generated near infrared light, which is invisible to the human eye, into visible light. The amplification process enables the user of night vision equipment to detect objects in the dark that either emit or reflect very low intensity light levels. These devices also take advantage of the fact that night time ambient light such as that produced by the moon, stars, and other low intensity light sources, is typically stronger in the near infrared portion of the electromagnetic spectrum than in the visible portion of the electromagnetic spectrum. The difference is sometimes one or two orders of magnitude. For example, FIG. 1 shows an average night time spectral distribution 2 of energy across visible and near infrared portions 4, 6, respectively, of the electromagnetic spectrum. There are several strong peaks 2a-2c in the energy distribution in the near infrared portion 6. Consequently, night vision equipment is designed with enhanced sensitivity to the infrared portion of the electromagnetic spectrum. As illustrated in FIG. 1, each succeeding generation of night vision equipment has generally increased the sensitivity over the near infrared region of the electromagnetic spectrum. Third generation (Gen III) NVGs are made with a gallium arsenide image intensifying tube that has a spectral range between 450 nm and 950 nm. Gen III NVGs used by aviator's also incorporate different minus-blue filters so as to optimize the spectral range for specific applications. For example, Gen III Class A NVGs incorporate a 625 nm minus-blue cut-on filter and are typically used by helicopter pilots. In contrast, Gen III Class B NVGs incorporate a 665 nm minus-blue cut-on filter and are used by fighter or cargo plane pilots. In addition, Gen III Class C NVGs incorporate a minus-blue cut-on filter and are used by pilots that rely on head-up displays (HUDs).

Night vision goggles typically include an automatic gain control circuit (AGC) that adjusts the light amplification level. The AGC responds to the strongest detected radiation and reduces the gain as needed to avoid saturating, and potentially damaging, the light imaging amplifier. When a source light too bright for the night vision equipment enters the field of view, the light imaging amplifier is momentary overloaded, the viewer observes a bright flare of light, also known as blooming, before the AGC reduces the gain of the amplifier. When the gain of the amplifier is reduced, the night vision equipment is less sensitivity to impinging light and the viewer observes a darken image.

The instrumentation and controls industry is typically concerned with illumination of small switched, button or display devices. The switch, button or display device often includes a translucent or transparent housing or cover which passes light from a source positioned behind the switch, button or display device directly toward the subject perceiving the illuminated instrumentation (e.g., pilot). The distances are typically rather short, since the instrumentation is typically within the physical reach and/or visual reading range of the subject.

The instrumentation and controls industry manufactures instrumentation and controls that contain lighting that is designed for environments that use night vision equipment such as inside an aircraft cockpit. For example, instrument lighting, map lights, liquid crystal displays (LCDs), etc., are designed to emit sufficient light in the visible portion of the electromagnetic spectrum to allow a pilot to operate with unaided vision. In addition, the electro-optical instruments are designed to be operated without interfering with the near infrared sensitivity of the night vision equipment. Typical designs include a filter to reduce the near infrared radiation produced by an incandescent or fluorescent lamp.

In recent years, the instrumentation and controls industry has started to manufacture equipment that contain light emitting diodes (LEDs) instead of incandescent or fluorescent lamps. LEDs are more efficient light producers than previously employed incandescent light sources. LEDs also have a longer working life than other technologies; thereby reducing maintenance and inventory costs. Thus, for example, the industry has started to exploit the benefits of LEDs as the illumination source in LCD backlights. These newer LCDs typically employ white light, produced either by phosphor coated LEDs, or combinations of colored LEDs. White LEDs exhibit broad band spectrum and are readily detected by night vision equipment. Again, typical designs employ a filter to block the near infrared portion of the spectrum. Unfortunately, filtering wastes a significant portion of the emitted energy and reduces the overall efficiency of the system.

A fundamental principle of LED operation long accepted by the semiconductor fabrication industry is that any LED emits light at a wavelength that is inversely proportionate to the band gap of the semiconductor material from which the LED is formed. Thus, material with a band gap of approximately 1.91 eV will produce a red light with a wavelength of about 650 nm. The recent advent of LEDs using gallium nitride (GaN) and indium gallium nitride (InGaN), makes available highly efficient LEDs that emit at the in the blue and green portions of the visible spectrum.

It is commonly accepted in the instrumentation and controls industry that LEDs that emit visible light furthest away from the near infrared potion of the electromagnetic spectrum will be readily visible to the unaided eye while not interfering with typical night vision equipment. It is also commonly accepted in the instrumentation industry that GaN and InGaN LEDs that emit visible light in the blue and green portions of the electromagnetic spectrum are spaced sufficiently far from the infrared portion so as to not interfere with night vision equipment.

It is further commonly accepted in the instrumentation industry that night vision equipment is not sensitive to radiation beyond 930 nm in the near infrared portion of the electromagnetic spectrum. This belief has been encouraged in part by the Military Specification MIL-STD-3009 and MIL-L-85762A which sets the standards for the spectral sensitivity range of night vision equipment. Such standards suggest that night vision equipment is not sensitive to radiation above approximately 930 nm. It is even further commonly accepted in the instrumentation and controls industry that filtering of LED light sources should be minimized to prevent loss of emitted energy, to reduce manufacturing costs, and/or increase system efficiency.

### BRIEF SUMMARY OF THE INVENTION

GaN/InGaN LED technology provides a number of additional advantages over other LED technologies. The human eye is most sensitive to green light. Green or blue-green (cyan) GaN/InGa/N LEDs are highly efficient light sources, requiring less power than other potential sources. It is well understood that the principle band-gap of the cyan and green LEDs produces light that efficiently overlaps with both the photopic and scotopic response of the human eye, but the overlap with the spectral response of night vision equipment is inefficient. Hence, green and cyan GaN/InGaN LEDs are potentially bright, low power, low maintenance light sources with less night vision equipment interference than other sources.

These advantages may be used in industries other than the instrumentation industry, which also require night vision compatibility, such as the area illumination or lighting industry. For example, naval vessels must be capable of day or night operations. It is not practical or desirable to provide each sailor on deck with night vision equipment. Accordingly, area lighting is necessary to permit the sailors to function while on deck at night. In addition, the area lighting should not be visible to night vision equipment at long distances in order to prevent detection of the vessel by enemy observers in air or sea craft, or while the ship is operating near the shore. Furthermore, in the case of aircraft carriers and amphibious assault ships, the area lighting should not interfere with the night vision equipment, such as a gain reduction of night vision equipment worn by pilots who are landing on, or taking off from, the deck. Consequently, the area lighting should be night vision compatible.

In one aspect, an area light fixture for illuminating an exterior area comprises: an opaque housing having at least one aperture formed therethrough; at least one light emitting diode received in the housing and positioned to transmit electromagnetic radiation through the aperture of the housing, the light emitting diode having a band gap of at least approximately 2 eV; and at least one filter positioned with respect to the aperture of the housing to substantially block electromagnetic radiation having a wavelength of approximately 950 nm emitted by the light emitting diode from emanating from the area light fixture to the exterior area. The filter may substantially block wavelengths greater than approximately 930 nm, 900 nm or 700 nm, and may block wavelengths up to or above approximately 1000 nm. The gallium nitride semiconductor material may take the form of an indium gallium nitride semiconductor material.

In another aspect, a light fixture for providing area lighting for use in night vision environments comprises: at least one gallium nitride based semiconductor device operable to emit electromagnetic radiation; and an optical filter positioned to substantially reduce emission of electromagnetic radiation having wavelengths between approximately 930 nm and at least 1000 nm from the light fixture. The filter may substantially block wavelengths greater than approximately 900 nm or 700 nm, and may block wavelengths up to or above approximately 1000 nm. The gallium nitride semiconductor material may take the form of an indium gallium nitride semiconductor material.

In still another aspect, an area lighting device comprises: a plurality of light emitting diodes, each including at least a gallium nitride semiconductor material and operable to emit electromagnetic radiation; and means for filtering electromagnetic radiation emitted by the light emitting diodes having wavelengths between approximately 930 nm and 1000 nm from emanating from the area light device. The filter may substantially block wavelengths greater than approximately 900 nm or 700 nm, and may block wavelengths up to or above approximately 1000 nm. The gallium nitride semiconductor material may take the form of an indium gallium nitride semiconductor material.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a graph showing average night time spectral distribution at the earth's surface across visible and near infrared portions of the electromagnetic spectrum.

FIG. 2 is a graph showing a portion of the electromagnetic spectrum including the visible and near infrared portions, illustrating 1) the relative sensitivity of the human eye, 2) the expected emission curves of several GaN devices based on instrumentation industry assumptions, as well as 3) the response of night vision equipment as specified by U.S. military specification MIL-STD-3009 and MIL-L-85762A and assumed by the instrumentation industry.

FIG. 3 is a graph showing the actual emission curves resulting from tests of commercially available samples of InGaN LEDs in the blue (˜465 nm), cyan (˜500 nm), and green (˜535 nm) wavelengths, and also showing the actual sensitivity of typical third generation night vision equipment as reported by a night vision equipment supplier.

FIG. 4 is an isometric view of a number of area light fixtures illuminating an area located on a ship, according to one illustrated embodiment.

FIG. 5 is a cross sectional view of an area light fixture showing a set of light emitting diodes integrally formed in a substrate and an optical filter assembly to filter infrared radiation according to one illustrated embodiment.

FIG. 6 is a cross sectional view of an area light fixture showing a set of light emitting diodes carried by a circuit board and a multilayer optical filter assembly to filter infrared radiation according to another illustrated embodiment.

FIG. 7 is a cross sectional view of an area light fixture showing a light emitting diode carried by a circuit board and an optical filter assembly substantially surrounding the light emitting diode according to another illustrated embodiment.

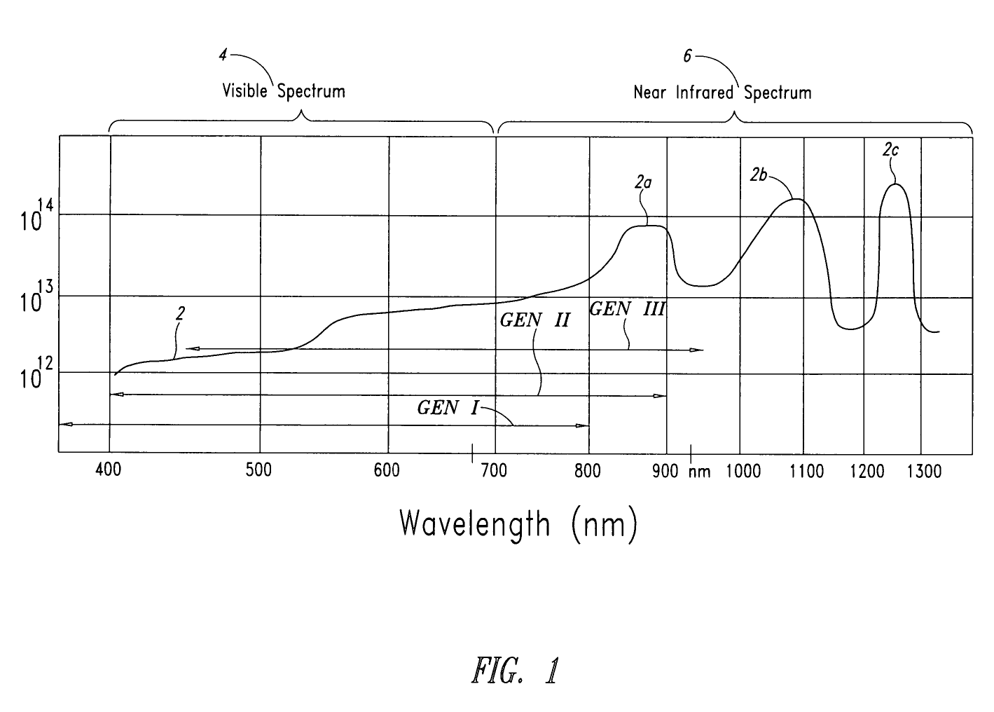

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated filter or with lighting systems, for example power supplies, switches and control circuits, or the various possible structural forms of specific sources of light such as various forms of light emitting diodes have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the embodiments.

The inventor has recognized that even at the trace levels, contaminants resulting from the LED manufacturing process may cause GaN or InGaN light emitting diodes to emit detectable energy at the wavelengths well outside of the principle band-gap. These emission bands are detectable by night vision equipment. This is confirmed by reference to the article, Photoluminescence study of the 1.047 eV emission in GaN, Pressel and Nilsson (Journal of Applied Physics 79, 15 Mar. 1996) Pressel, which attributes luminescence bands at 1.13 eV, 1.19 eV, and 1.047 eV in samples of gallium nitride detected by laser excitement to transition metals introduced as natural contaminants during formation of the crystal structure.

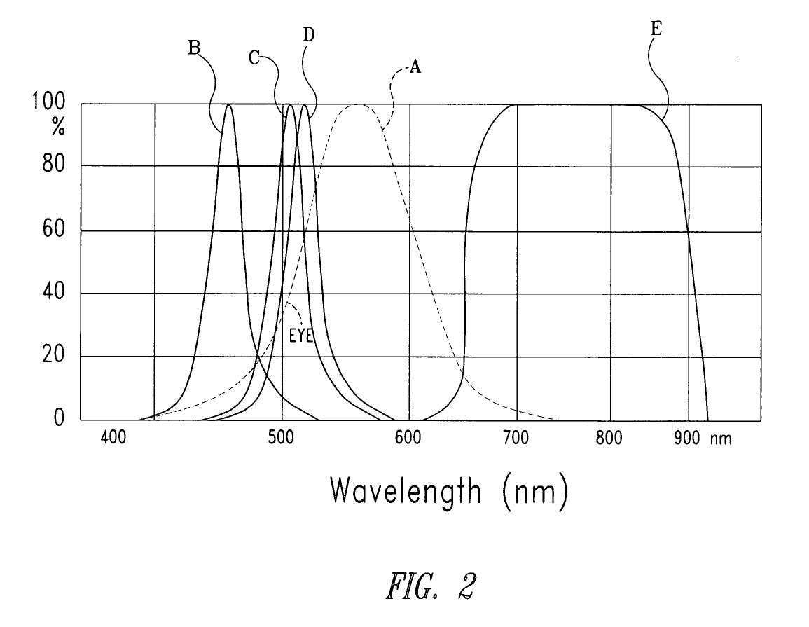

FIG. 2 shows a portion of the electromagnetic spectrum which includes the visible and near infrared light. Curve A shows the relative sensitivity of the human eye across the visible portion of the spectrum. Curves B, C, and D show the emission profiles of several GaN devices as found in the technical data of a commercial supplier and as commonly accepted by the instrumentation industry. Notably, no emission is expected at or beyond the 600 nm. Curve E shows the response of night vision equipment as specified by U.S. military specification MIL-STD-3009, and as commonly accepted by the instrumentation industry. Notably, the night vision equipment appears to be unresponsive at or below 600 nm and unresponsive at or above approximately 930 nm.

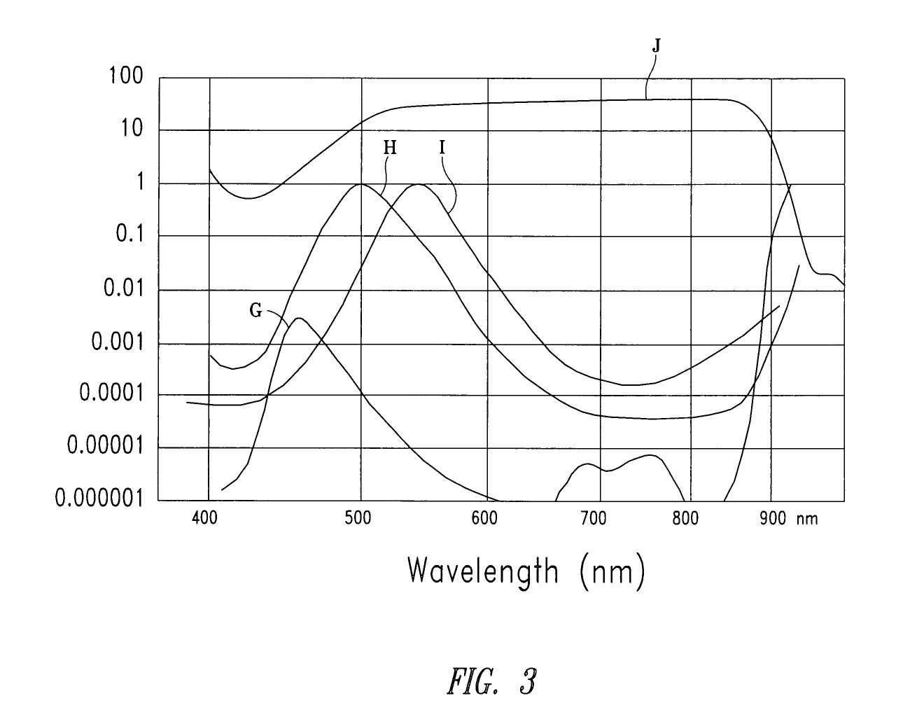

FIG. 3 is a graph showing the actual emission profiles resulting from tests conducted by the inventor using representative sample InGaN LEDs obtained from commercial suppliers. In particular, curve G represents the emission profile of an InGaN LED that emits in the blue (˜465 nm) range. Curve H represents the emission profile of an InGaN LED that emits in the cyan (˜500 nm) range. Curve I represents the emission profile of an InGaN LED that emits in the green (˜535 nm) range.

The emission profile of each of the LEDs has a first peak at the expected wavelength corresponding to the principle LED band-gap, but importantly has an unexpected second peak well within the near-infrared range. In the case of the blue LED (Curve G), the second peak is approximately two orders of magnitude greater than the peak in the visible spectrum. The emission profiles of the LEDs each show a rising curve at the test cutoff, around 935 nm, so the exact amplitude and frequency of the second peak was not determined. Nevertheless, the emission profile of each LED clearly showed significant levels of infrared emissions that probably extend well beyond the cutoff. The inventor has measured additional devices and found that the amplitude and location of a second peak is unpredictable, and may vary from manufacturer to manufacturer, or even between production lots of one manufacturer.

This result is extremely unexpected, inasmuch as it has long been understood in the instrumentation and controls industry that the principle band gap of an LED emits a single wavelength (see FIG. 2). Without being limited by theory, the inventor has surmised that this phenomenon may have been previously overlooked for any of several reasons: 1) spectral emissions of LEDs may not have been previously examined outside of the expected ranges of operation; 2) emissions previously detected outside the visible spectrum may have been ignored as unimportant in a commercial device configured to operate within the visible spectrum; 3) LEDs having other formulations may not exhibit such strong IR emissions; 4) GaN and InGaN devices were first exploited for their extraordinary efficiency in the visible spectrum, it was only after their introduction in more conventional applications that the advantages with respect to night vision equipment began to be appreciated, so rigorous testing outside the expected ranges may never have been considered.

FIG. 3 also shows the sensitivity of the photocathodes employed by typical third generation night vision equipment, represented by the Curve J. Notably, this sensitivity differs from that defined by Military Specification MIL-STD-3009 and MIL-L-85762A, which is commonly relied on by the instrumentation and controls industry to design instrumentation that is compatible with night vision equipment. In particular, third generation night vision equipment is sensitive further into the infrared portion of the electromagnetic spectrum than generally accepted in the instrumentation and controls industry. That extended sensitivity unfortuitously includes the secondary peaks in the measured emission profiles of the GaN LEDs.

The instrumentation industry and night vision equipment users may not have appreciated the existence of the secondary peaks or their negative consequences since a user will not necessarily be aware that a light source is affecting the gain of night vision equipment. As described above, the image seen through the night vision equipment may simply be darker than usual, due to the decreased gain. Additionally, the user may be accustomed to conventional lighting systems that leak significant infrared radiation, and so will not realize that the image is less than optimal. Without being limited by theory, these may be some of the reasons why the excessive infrared emissions of lighted instrumentation has not been detected in the field.

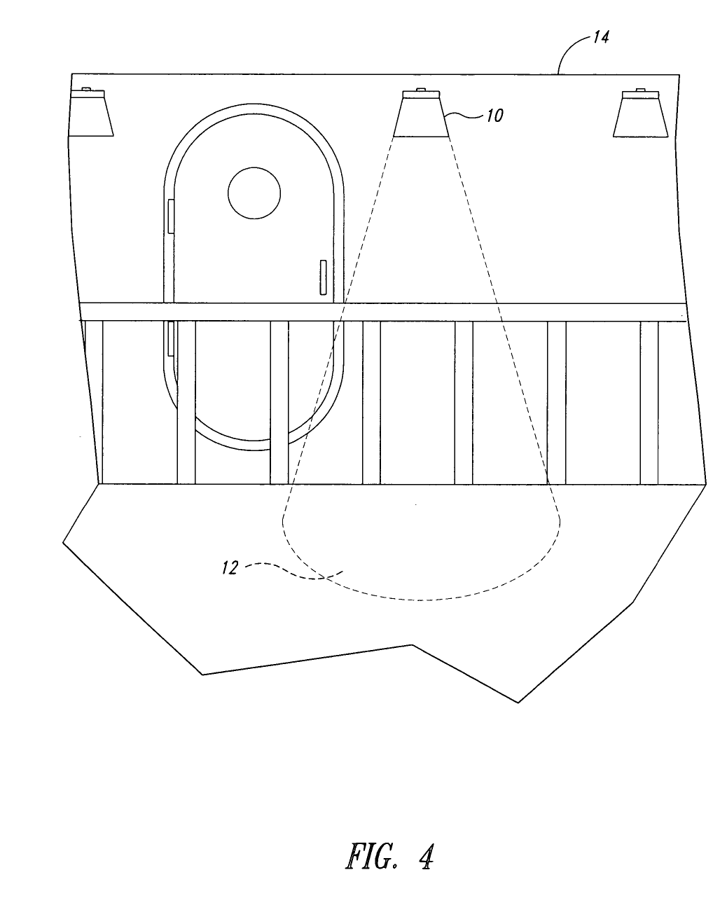

FIG. 4 shows a number of area light fixtures 10 illuminating an area 12 such as an airfield, landing craft or deck of a ship 14 according to one illustrated embodiment. Area light fixtures 10 include spotlights, floodlights, shipboard deck lights, overhead lights, flashlights, and control panel post lights and other light capable of substantially illuminating an area externally from the fixture sufficiently to allow personnel to carry one operations. This is in contrast to lighting for instrumentation, such a lighted switches or displays, for example LCDs.

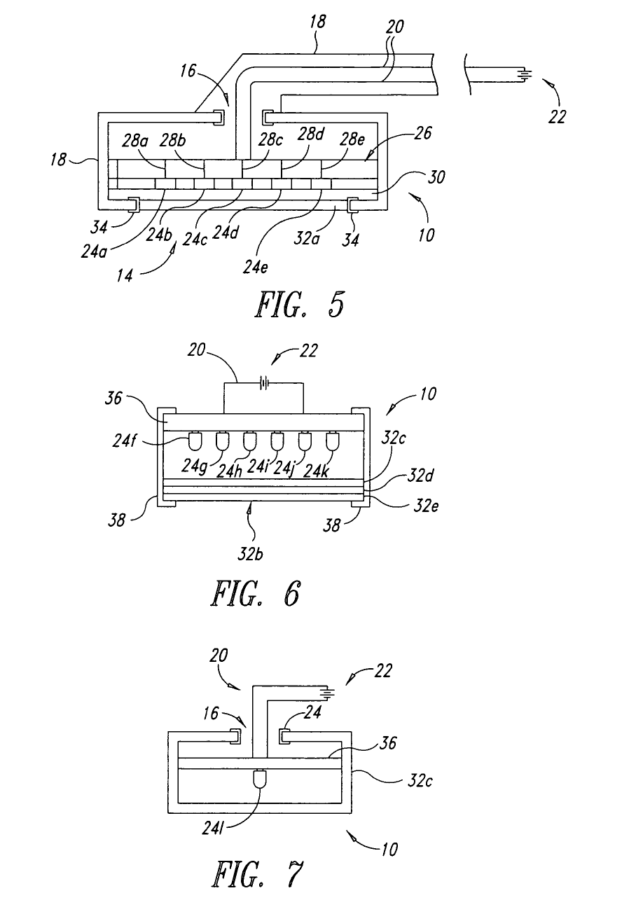

FIG. 5 shows the area light fixture 10 including an opaque housing 18 having a first aperture 14 to allow the passage of electromagnetic radiation. The housing 18 may optionally include a second aperture 16 that provides communication via a bracket or support 18 for an electrical coupling 20 to a power source 22. A first seal or gasket 24 may provide a light tight seal about the second aperture 16. The bracket or support 18 may be used to physically mount the area light fixture 10 to an appropriate support, for example a wall or pole.

The area light fixture 10 also includes a number of LEDs 24a-24e integrally formed in a substrate 26. Each of the LEDs 24a-24e may be coupled to one polarity of the power source 22 by a conductor filed via 28, and coupled to the other polarity, for example, via a light transmissive conductive layer 30 such as a layer formed from Indium-Tin Oxide (ITO).

The substrate 26 may include one or more layers, including conductors, semiconductors and/or insulators, as is generally known in the solid state fabrication arts. Each of the LEDs 24a-24e may advantageously comprise a semiconductor material with a band gap equal or greater than approximately 2 eV to cause electroluminescence below the red wavelengths in the visible portion of the electromagnetic spectrum. As noted above, spacing the wavelength of the emitted radiation away from the infrared portion of the electromagnetic spectrum reduces interference with night vision equipment. More advantageously, semiconductor material may have a band gap equal or greater than approximately 2.5 eV to cause electroluminescence even further from red wavelengths in the visible portion of the electromagnetic spectrum. As noted above, the human eye is most sensitive to green light. Thus, causing electromagnetic radiation to be emitted at the green wavelengths of the visible portion of the electromagnetic spectrum advantageously allows a reduction in power while achieving adequate lighting of an area. Also, more advantageously, semiconductor material may have a band gap equal or greater than approximately 3 eV. While the human eye may not be as sensitive to the blue wavelengths of the visible portion of the electromagnetic spectrum, such wavelengths are spaced even further from the infrared portion than are the green wavelengths. Thus, such wavelengths may interfere less with night vision equipment. The LEDs 24a-24e may, for example, advantageously employ a gallium nitride based semiconductor material such as gallium nitride or indium gallium nitride, which have sufficiently high band gaps to provide the above described advantages.

The area light fixture 10 further includes a filter assembly 32a positioned to filter electromagnetic radiation emanating from the housing 18 via the first aperture 14. A second seal or gasket 34 may provide a light tight seal between the first aperture 14 and the filter assembly 32a.

As illustrated in FIG. 5, the filter assembly 32a may comprise an integral formed filter element capable of substantially blocking electromagnetic radiation having a wavelength of approximately 950 nm, at what appears to be the high point of the second peak in the emission profiles. In particular, the filter assembly 32a may be capable of substantially blocking electromagnetic radiation having a wavelength greater than approximately 930 nm, the point at which the second peak in the emission profiles approaches what appears to be the maximum. More advantageously, the filter assembly 32a may be capable of substantially blocking electromagnetic radiation having a wavelength greater than approximately 900 nm where the intensity of the second peak becomes particularly significant. Even more advantageously, the filter assembly 32a may be capable of substantially blocking electromagnetic radiation having a wavelength greater than approximately 700 nm to ensure that all electromagnetic radiation associated with the second peak in the emission profiles is substantially blocked. Each increase in the range of wavelengths being blocked should be weighed against the likely increase in cost of the filter assembly 32a, the reduction of light fixture efficiency and/or the likelihood and significance of the wavelengths interference with night vision equipment.

For practical and cost reasons, the filter assembly 32a may have an upper range which may be approximately 1000 nm, or greater. Such ensures that the radiation emitted by the LEDs 24a-24e, particular the second peak in the emission profiles, will not interfere with third generation night vision equipment.

FIG. 6 shows the area light fixture 10 according to another illustrated embodiment. In the embodiment of FIG. 6, discrete LEDs 24f-24k are mounted to a circuit board 36, for example a printed circuit board, which may include conductive traces and/or vias for providing electrical coupling between the LEDs 24f-24k and power source 22. The LEDs 24f-24k may have similar characteristics to the LEDs 24a-24e generally described above.

A bracket 38 may be provided to physically couple the circuit board 36 with a filter assembly 32b. The bracket 38 may allow the area light fixture 10 to be mounted to a suitable support, such as a ceiling or arm of a post. In such a situation, the ceiling or other object may function as an opaque housing.

As further illustrated in FIG. 6, the filter assembly 32b may comprises multiple layers of filter elements and/or other optical components 32c-32e For example, each layer 32c-32e may filter a selected portion of the entire range of electromagnetic radiation that is desired to be filtered. This may provide a more commercially practical alternative than forming the integral filter assembly 32a having a band selectivity of the desired range. The filter assembly 32b may have similar characteristics to the filter assembly 32a described above.

FIG. 7 shows the area light fixture 10 according to another illustrated embodiment. In the embodiment of FIG. 7, a discrete LED 24l is mounted to a circuit board 36, for example a printed circuit board, which may include conductive traces and/or vias for providing electrical coupling between the LED 24l and power source 22 via electrical coupling 20. A filter assembly 32c substantially surrounds the light emitting diode 24l, having a single aperture 16 to provide communication or conduit for the electrical coupling 20. The area light fixture 10 of FIG. 7 may be simply and quickly mounted to a wall, ceiling or pole using standard brackets and/or fasteners. A seal or gasket 24 may provide a light tight seal about between the aperture 16 and the structure to which the area light fixture is mounted.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the embodiments can be applied to other area lighting systems, not necessarily the exemplary ship board area light fixture generally described above. For example, one or more area light fixtures may be employed on a landing craft or airfield to ensure that area is not visible to a distant enemy using night vision equipment. In addition, the teachings provided herein of the embodiments can also be applied to GaN/InGaN LED based night vision equipment compatible flashlights that are typically used by forward deployed infantry soldiers.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the invention to the specific embodiments disclosed in the specification and the claims, but should be construed to include all area light fixtures that operated in accordance with the claims. Accordingly, the invention is not limited by the disclosure, but instead its scope is to be determined entirely by the following claims.

1. An area light fixture for illuminating an exterior area, the area light fixture comprising:
an opaque housing having at least one aperture formed therethrough;
at least one light emitting diode received in the housing and positioned to transmit electromagnetic radiation through the aperture of the housing, the light emitting diode having a band gap of at least approximately 2 eV; and
at least one filter positioned with respect to the aperture of the housing to substantially block electromagnetic radiation having a wavelength of approximately 950 nm emitted by the light emitting diode from emanating from the area light fixture to the exterior area.

2. The light fixture of claim 1 wherein the filter substantially blocks electromagnetic radiation having a wavelength greater than approximately 930 nm.

3. The light fixture of claim 1 wherein the filter substantially blocks electromagnetic radiation having a wavelength greater than approximately 900 nm.

4. The light fixture of claim 1 wherein the filter substantially blocks electromagnetic radiation having a wavelength greater than approximately 700 nm.

5. The light fixture of claim 1 wherein the filter substantially blocks electromagnetic radiation having a wavelength between approximately 930 nm and at least approximately 1000 nm.

6. The light fixture of claim 1 wherein the filter substantially blocks electromagnetic radiation having a wavelength between approximately 900 nm and at least approximately 1000 nm.

7. The light fixture of claim 1 wherein the filter substantially blocks electromagnetic radiation having a wavelength between approximately 700 nm and at least approximately 1000 nm.

8. The light fixture of claim 1 wherein the light emitting diode has a band gap of greater than approximately 2.5 eV.

9. The light fixture of claim 1 wherein the light emitting diode has a band gap of greater than approximately 3 eV.

10. The light fixture of claim 1 wherein the light emitting diode is a gallium nitride light emitting diode.

11. The light fixture of claim 1 wherein the light emitting diode is an indium gallium nitride light emitting diode.

12. The light fixture of claim 1 wherein the filter is positioned to filter electromagnetic radiation emitted from at least two light emitting diodes.

13. The light fixture of claim 1, further comprising:
a common substrate carrying a plurality of the light emitting diodes, wherein the filter is formed as a layer over the plurality of the light emitting diodes.

14. A light fixture for providing area lighting for use in night vision environments, the light fixture comprising:
at least one gallium nitride based semiconductor device operable to emit electromagnetic radiation; and
an optical filter positioned to substantially reduce emission of electromagnetic radiation having wavelengths between approximately 930 nm and at least 1000 nm from the light fixture.

15. The light fixture of claim 14 wherein the optical filter also substantially reduces emission of electromagnetic radiation having wavelengths between approximately 900 nm and approximately 930 nm from the light fixture.

16. The light fixture of claim 14 wherein the optical filter also substantially reduces emission of electromagnetic radiation having wavelengths between approximately 700 nm and approximately 930 nm from the light fixture.

17. The light fixture of claim 14 wherein the gallium nitride semiconductor device is a gallium nitride light emitting diode.

18. The light fixture of claim 14 wherein the gallium nitride semiconductor device is an indium gallium nitride light emitting diode.

19. The light fixture of claim 14, further comprising:
a power supply circuit having an input terminal configured to receive a voltage at a first potential and provide a voltage at a second potential to the LED.

20. The lighting fixture of claim 14 wherein the optical filter substantially surrounds the at least one gallium nitride based semiconductor device, the optical filter having an light sealed aperture to provide electrical communication between the at least one gallium nitride based semiconductor device and a power source.

21. An area lighting device, comprising:
a plurality of light emitting diodes, each including at least a gallium arsenide semiconductor material and operable to emit electromagnetic radiation; and
means for filtering electromagnetic radiation emitted by the light emitting diodes having wavelengths between approximately 930 nm and 1000 nm from emanating from the area light device.

22. The area lighting device of claim 21 wherein the means for filtering further filters electromagnetic radiation emitted by the light emitting diodes having wave lengths between approximately 900 nm and approximately 930 nm.

23. The area lighting device of claim 21 wherein the means for filtering further filters electromagnetic radiation emitted by the light emitting diodes having wave lengths between approximately 700 nm and approximately 930 nm.

24. The area lighting device of claim 21 wherein the gallium arsenide semiconductor material of each of the light emitting diodes further includes indium.
